(19) United States
(12) Patent Application Publication
(10) Pub. No.: US 2026/0326958 A1
(43) Pub. Date: Oct. 22, 2026

(54) METHOD FOR DETECTING A NUMBER OF GROUPED PRODUCTS AND DEVICE FOR THIS PURPOSE

(71) Applicant: OPTIMA nonwovens GmbH, Schwäbisch Hall (DE)

(72) Inventor: Kai-Uwe Ohling, Schwäbisch Hall (DE)

(73) Assignee: OPTIMA nonwovens GmbH, Schwäbisch Hall (DE)

(21) Appl. No.: 19/651,094

(22) Filed: Apr. 17, 2026

(30) Foreign Application Priority Data
Apr. 17, 2025 (DE) 102025115096.6

(51) Int. Cl. B65B 65/08; G01J 5/00; G01J 5/48

(52) U.S. Cl. CPC B65B 65/08; G01J 5/48; G01J 2005/0077

(57) ABSTRACT

The invention relates to a method for detecting a number of grouped products (10), such as diapers, that are transported along a conveyor line (9). The invention further relates to a device (100) for carrying out the method and a system (1000) for packaging products, comprising a packaging machine for grouping and packaging the products (1) and such a device (100). It has been recognized that products to be packaged (1) retain residual heat from their preceding manufacturing process, and, according to the invention, the thermal radiation emitted by the products after they have been grouped can be advantageously measured and evaluated to determine their quantity, e.g., using a thermal imaging camera.

### CROSS-REFERENCE TO RELATED APPLICATION

The present application claims priority to German Patent Application No. 102025115096.6, filed Apr. 17, 2025, the entirety of which is incorporated herein by reference.

### DESCRIPTION

The invention relates to a method for detecting a number of grouped products being transported along a conveyor line. The invention further relates to a device for carrying out the method and a system for packaging products, comprising a packaging machine for grouping and packaging the products and such a device.

### PRIOR ART

In the case of product packages containing multiple products, the products are placed into the package using packaging machines known in the prior art, and the package is then sealed.

A wide variety of packages, such as boxes, tins, and bags, made from a wide range of materials—including paper, cardboard, and plastic—is used.

If the products are items with low structural stability, their handling during the packaging process requires a plurality of special precautions.

EP 0 400 598 B1 describes a packaging machine for packaging compressed items, specifically diapers. In this process, a stack of diapers-that is, a number of grouped diapers—is compressed by pressing the wide faces of the first and last diapers in the stack; the compressed stack is then inserted sideways into a packaging bag while still compressed, and the bag is then sealed.

In the modern manufacturing and packaging industry, verifying the completeness of packaged products is essential to ensuring product quality and preventing customer complaints. Conventional optical inspection methods reach their limits when dealing with non-transparent packaging.

Alternatively, the correct fill quantity in the package can be determined by using scales. However, due to manufacturing processes, there are variations in the weight of individual products, which—particularly in the case of absorbent hygiene products—can range in the low double digits. These fluctuations are amplified when multiple products are grouped or combined in a single package, so that once a certain number of products are grouped together, a shortage in the package can no longer be reliably detected by weighing.

### OBJECT AND SOLUTION

The object of the present invention is to describe a method for detecting a number of grouped products that enables fast and reliable counting, particularly of products already contained in a package. Such a method can also be referred to as a completeness check.

Another object of the invention is to provide a device for carrying out the method and a system for packaging products using such a device, which enables fast and reliable counting, particularly of products that are already inside a package.

This object is solved by a method for detecting a number of grouped products being transported along a conveyor line, as described and claimed below.

It has been recognized that products to be packaged retain residual heat from their preceding manufacturing process, and, according to the invention, the thermal radiation emitted by the products after they have been grouped can be advantageously measured and evaluated to determine their quantity.

The method of the invention for detecting a number of grouped products comprises the following steps:
Enclosing the grouped products with packaging material;
Conveying the grouped products along a conveyor line, wherein the products are conveyed together as a single unit and pass through a detection zone of a thermographic detection device.
Generating a thermal image of the grouped products using the thermographic detection device. The detection device measures the heat emissions from the products. The measuring can take place either during the transport movement or during a brief pause.
Then analyzing the generated thermal image using a data processing unit with a counting algorithm to determine the number of thermal signatures, wherein one thermal signature is assigned to each product, thereby inferring the number of products.

It has been observed that, due to prior heat input during its manufacturing, processing, and/or transport, each product exhibits a characteristic heat distribution across its surface and/or throughout its cross-section. For example, a product may have more thermal energy at its center and less at its edges, giving it a unique thermal signature. Based on the thermal signatures measured in a thermal image, image-processing counting algorithms can thus be used to determine the number of grouped products.

It is advantageous to enclose the grouped products in packaging material because the number of grouped products is only counted once they have been packaged and their quantity can no longer change. This makes it possible to inspect the finished, packaged products.

The method of the invention advantageously enables improved quality assurance through the accurate and rapid counting of grouped products.

The method continues with an additional step:

Comparing the actual number of products with a target value. The target value can be stored in the data processing unit, entered into it, or imported into it. This additional method step makes it possible to determine whether a set of grouped products is complete.

The method continues with an additional step:
Triggering an action based on the comparison result obtained as described above, wherein if the actual number matches the target number, the grouped products are conveyed further and/or processed further, and if the actual number does not match the target number, the grouped products are ejected or marked and/or a communication signal is issued. Marking can be done, for example, by printing—particularly using inkjet or laser printers—or by labeling, specifically by applying a label or self-adhesive label, and enables subsequent ejecting or sorting. The communication signal may be a visual signal—such as a warning light—or an audible signal—such as a warning tone—each serving as a warning to a machine operator, or it may be a digital signal sent to the machine control system.

In one embodiment of the method, the grouped products are placed into a package.

During the method, the detection device measures the heat emissions from the products through the packaging material. For this to work, the packaging material must be at least partially “heat-transparent,” meaning that the heat emitted by the products must be able to pass through the packaging material to a degree that can still be measured by the detection device.

Examples of packaging materials include PE films, other plastic films, thin paper webs, or other cellulose webs. The package could then consist of bags or pouches made from that material. If “heat-opaque” packaging materials are used, they may include cutouts or windows made of “heat-transparent” packaging material.

In a further embodiment of the method, the grouped products are arranged in layers or stacked. With products grouped in this way, it is difficult to determine the number of grouped products using conventional cameras and subsequent image analysis, and the results are prone to inaccuracies. The use of a thermographic detection device, as described in the invention, solves these challenges, as the individual thermal signatures of the respective products can be clearly distinguished from one another during image analysis.

For the purposes of this method, the products in question are absorbent hygiene products, such as diapers, menstrual products, incontinence pads, wipes, or toilet paper.

In one embodiment of the method, the thermographic detection device comprises at least one infrared sensor for at least one-dimensional detection or at least one thermal imaging camera for two-or three-dimensional detection of a thermal image, which is used to scan the heat emissions of the grouped products. An infrared sensor for one-dimensional detection can be designed as a line scan camera. A 2D image could then be generated from the one-dimensional image lines of the line scan camera. The features of the thermal imaging camera, such as the lens and resolution, as well as its distance from the grouped products, are at the discretion of the specialist. Thermal imaging cameras suitable for this purpose are readily available on the market. To improve the quality of the thermal images, multiple infrared sensors and/or thermal imaging cameras can be combined within a single detection device.

In a further embodiment of the method, a preliminary step is provided prior to the execution of the other steps of the method during operation:
Adjusting the detection device based on the products to be detected and, if applicable, their package—specifically their type, geometry, material composition, etc.

To ensure optimal detection of the products'heat emissions, the detection device's parameters are adjusted. This may involve adjusting the wavelength range so that, for example, the heat emissions from the transported products are reliably detected rather than those from the conveying mechanism—such as a conveyor belt—that is transporting the products. This may also involve adjusting the focus, for example, to specifically detect the outer edges of the product or a specific area within the product.

In a further embodiment of the method, a preliminary step is provided prior to the execution of the other steps of the method during operation:
Training the counting algorithm, also known as “teaching,” particularly by marking individual thermal signatures in a set of thermal images. Alternatively, or in addition, the actual number of thermal signatures can be specified in a set of thermal images. The actual number can be entered either manually via an interface or using AI-assisted methods. It is also possible to specify how individual thermal signatures are characterized, for example, by the minimum and maximum number of contiguous pixels in a pixel chain, by specific brightness values, or by the contrast distribution of pixel chains. By defining such characteristics at a specific point of interest and excluding irrelevant image areas, a product can be distinguished from an adjacent product. Once the system has been trained, the counting algorithm can automatically analyze thermal images containing thermal signatures and determine the number of products.

In another aspect, the invention also relates to a device for detecting a number of grouped products, in particular for carrying out the method described above. The device comprises a conveyor device for conveying the grouped products, a thermographic detection unit for detecting a thermal image of the grouped products, and a control device that is connected via data transmission at least to the thermographic detection unit and includes a data processing unit with a counting algorithm for determining the number of grouped products. The components of the device may be configured as described above.

In a further embodiment of the device, the thermographic detection unit is arranged relative to the conveyor line such that all products pass through the detection zone of the thermographic detection device while being conveyed In addition, an optical axis of the detection unit is oriented at an angle and is not parallel to or located in the plane in which the products are grouped. In other words, for products stacked in a flat configuration, the optical axis of the detection unit is not perpendicular to the flat surface of the products. The arrangement of the detection unit is therefore determined by the orientation of the grouped products relative to one another. This ensures that all products are reliably counted and their quantities accurately determined.

In another aspect, the invention relates to a system for packaging products, comprising a packaging machine for grouping and packaging the products and a device as described above. The positioning of the detection device in such a system depends on its design, the embodiment of the system, the characteristics of the products, and the packaging process. When packaging items such as diapers, panty liners, toilet paper rolls, sanitary napkins, wipes, etc., into bags, a thermal imaging camera may be positioned before or after a sealing station used to seal the bag, for example, by heat-sealing it. In the latter case, the thermal imaging camera could also detect the seal created in the bag, and the seal quality of the sealing process could be checked through subsequent image analysis.

The invention described and the advantageous modifications thereof described also constitute advantageous modifications of the invention when combined with one another—to the extent that this is technically feasible.

With respect to further advantages and, in structural and functional terms, advantageous embodiments of the invention, reference is made to the dependent claims as well as the description of exemplary embodiments with reference to the attached figures.

### BRIEF DESCRIPTION OF THE DRAWINGS

The invention will be explained in greater detail with reference to the accompanying figures. Corresponding elements and components are identified by the same reference symbols in the figures. To make the figures easier to distinguish, they have not been depicted to scale.

The following is shown in a schematic diagram

FIG. 1 a device for detecting a number of grouped products

FIG. 2 an example thermal image of grouped products

FIG. 3a and b: possible arrangements of detection devices relative to the grouped products

FIG. 4 a system for packaging products

### DETAILED DESCRIPTION OF THE EXEMPLARY EMBODIMENTS

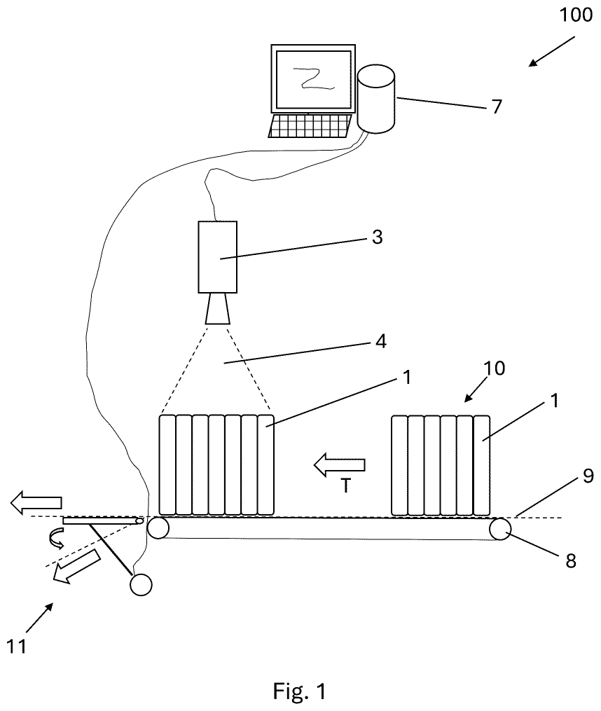

FIG. 1 shows a device for detecting a number of grouped products.

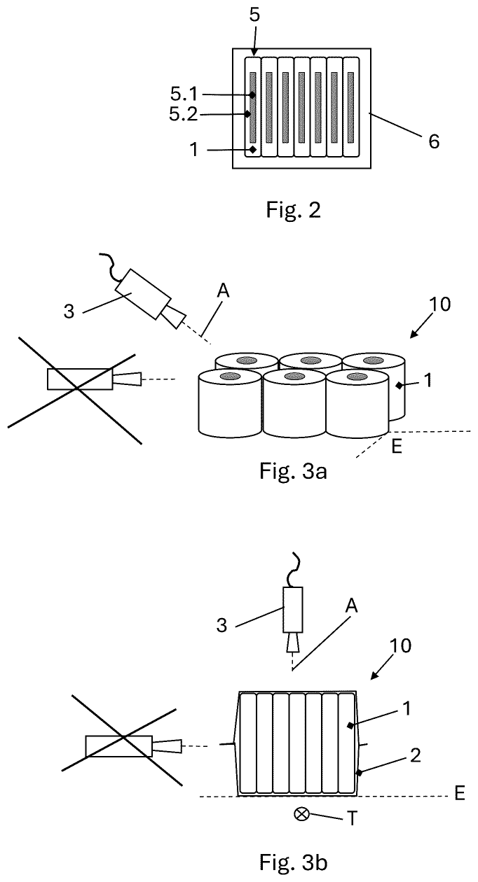

The device 100 for detecting a number of grouped products 10 includes a thermographic detection unit 3 for detecting a thermal image 6 (see FIG. 2) of the grouped products 10. In the illustrated embodiment, the thermographic detection device 3 comprises a thermal imaging camera. The individual products 1 are grouped into stacks, referred to as grouped products 10. Products 1 are absorbent hygiene products, such as diapers.

The device further comprises a conveyor device 8 for conveying the grouped products 10 in a conveying direction T. In the conveying direction T, the conveyor belt of the conveyor device 8 is followed by a ejection device with a diverter 11 for ejecting the grouped products 10. The grouped products 10, located downstream when viewed in the conveying direction, consists of seven individual products. The grouped products 10, located upstream when viewed in the conveying direction, consists of six individual products.

Thermographic detection unit 3 is connected to a control device 7 via data transmission. Control unit 7 comprises a data processing unit with a counting algorithm for determining the number of grouped products. The process of detecting a number of grouped products 10 is as follows:

The grouped products 10 are transported along a conveyor line 9, during which the products 1 pass through the detection zone 4 of the thermographic detection device 3. The thermographic detection device 3 generates a thermal image 6 of the grouped products 10. To analyze thermal image 6, the image data is transmitted to the data processing unit 7. A counting algorithm in the data processing unit 7 determines the number of thermal signatures 5 (see FIG. 2), wherein each product 1 is assigned a product-specific thermal signature 5, which in turn allows the number of products to be inferred.

Below, the actual number of products 1 is compared with the target value. Wherein, depending on the result of the comparison, an action is triggered; wherein the actual count matches the target count, the grouped products 10 are conveyed further and/or processed further, and if the actual number does not match the target number, the grouped products 10 are ejected by the ejection device 11, which is controlled accordingly by the control unit 7. For example, if the target number is six products, the seven grouped products downstream are discharged as 10.

FIG. 2 shows an example thermal image of grouped products. Each product 1 is assigned a thermal signature 5 from the thermal image 6. A given thermal signature 5 has characteristic features; specifically, in this example, it comprises a dark pixel region 5.1 and a bright pixel region 5.2, each of which is defined by a specific number of pixels.

FIG. 3 a and b show possible arrangements of detection devices relative to the grouped products.

In general, the thermographic detection device 3 is arranged such that all products 1 pass through the detection zone 4 of the thermographic detection device 3 while being conveyed.

In FIG. 3 a, six toilet paper rolls were grouped in a 3×2 matrix within a grouping plane E.

In FIG. 3b, seven diapers were stacked in a vertical position on a grouping plane E. The diapers were enclosed in packaging material 2 or placed inside bag-shaped package 2, which was then sealed. The products 1, grouped and packaged in this manner, can be conveyed in the conveying direction T (perpendicular to the image plane) through a detection device equipped with a thermal imaging camera 3.

A common feature of the two configurations of the detection device 3 shown in FIGS. 3a and 3b is that the optical axis A of the detection device 3 is at an angle to, and not parallel to, the grouping plane E in which the products are grouped.

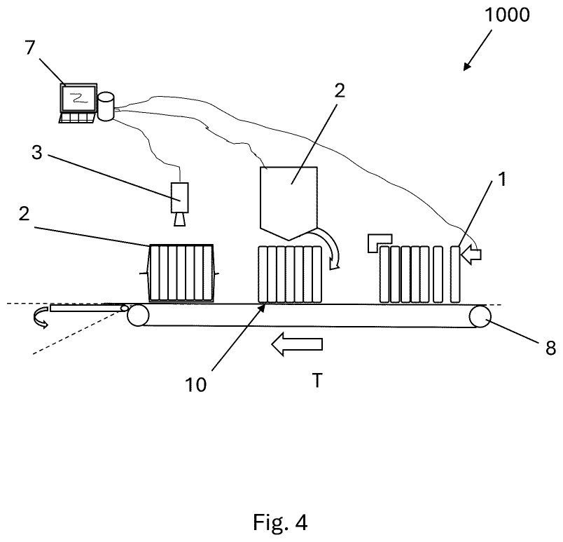

FIG. 4 shows a system for packaging products.

The system 1000 for packaging products 1 comprises—as viewed in the conveying direction T—a packaging machine for grouping products, including a device for combining individual products 1 into grouped products 10, and for packaging the grouped products 10 into a package 2, as well as a device 100, as described in detail above, for detecting a number of grouped products 10.

### LIST OF REFERENCES

1 product
2 packaging material/package
3 thermographic detection device
4 detection zone
5 thermal signature
5.1 darker pixel area
5.2 brighter pixel area
6 thermal image
7 control device with data processing unit and machine control
8 conveyor device
9 conveyor line
10 grouped products
11 ejection device
100 device for detecting products
1000 system for packaging products
A optical axis
E grouping plane
T conveying direction

What is claimed is:

1. A method for detecting a number of grouped products, comprising the following steps:
a) enclosing the grouped products with packaging material;
b) conveying the grouped products along a conveyor line, during which the products pass through the detection zone of a thermographic detection device;
c) generating a thermal image of the grouped products using the thermographic detection device; and
d) analyzing the thermal image using a data processing unit with a counting algorithm to determine the number of thermal signatures, wherein each product is assigned a thermal signature, and inferring the number of products.

2. The method according to claim 1, comprising the additional step of:
e) comparing the actual number of products with a specified target value.

3. The method according to claim 2, comprising the additional step of:
f) triggering an action based on the comparison result, wherein:
if the actual number matches the target number, the grouped products are conveyed further and/or processed further;
if the actual number does not match the target number, the grouped products are ejected or marked, and/or a signal is output.

4. The method according to claim 1, wherein, in step a), the grouped products are placed into a package.

5. The method according to claim 1, wherein the grouped products are layered or stacked and/or the products are absorbent hygiene products.

6. The method according to claim 1, wherein the thermographic detection device comprises at least one infrared sensor or at least one thermal imaging camera.

7. The method according to claim 1, comprising the preliminary step of:
training the counting algorithm.

8. A device for detecting a number of grouped products, in particular for carrying out the method according to claim 1, comprising a conveyor device for conveying the grouped products, a thermographic detection device for detecting a thermal image of the grouped products, and a control device, which is connected via data transmission at least to the thermographic detection unit and comprises a data processing unit with a counting algorithm for determining the number of grouped products.

9. The device according to claim 8, wherein the thermographic detection device is arranged such that all products pass through the detection zone of the thermographic detection device while being conveyed.

10. A system for packaging products, comprising a packaging machine for grouping and packaging the products and a device according to claim 8.
